(19) United States
(12) Patent Application Publication
(10) Pub. No.: US 2009/0250490 A1
(43) Pub. Date: Oct. 8, 2009

(54) DISPENSING DEVICE

(76) Inventor: EDWARD STRAZA, Ladysmith (CA)

Correspondence Address: James Ray & Associates, 2640 Pitcairn Road, Monroeville, PA, 15146, US

(21) Appl. No.: 12/417,249

(22) Filed: Apr. 2, 2009

Related U.S. Application Data
(60) Provisional application No. 61/072,861, filed on Apr. 3, 2008.

(51) Int. Cl. B67D 5/60; B67D 5/63; B67D 5/06; B67D 3/00

(52) U.S. Cl. 222/132; 222/135; 222/146.5; 222/181.3; 222/559; 222/143

(57) ABSTRACT

A dispensing device includes a plurality of housing members of substantially the same height and depth for housing a plurality of predetermined consumable items therein. A securing mechanism is disposed at predetermined locations on such housing members for releasably securing such housing members to each other. At least one housing member receives and stores a predetermined amount of a predetermined liquid therein. A heating source is operably connected to such at least one housing member for heating such predetermined liquid. A power source is operably connected to such heating source for supplying power thereto. A switch mechanism is disposed intermediate such power source and such heating source for selectively turning such power source on and off. A dispensing mechanism is operably connected to each of such plurality of housing members for dispensing such predetermined consumable items from within such housing members outside of such housing members into predetermined containers.

### CROSS REFERENCE TO RELATED APPLICATION

This patent application is related to and claims priority from U.S. Provisional Patent Application Ser. No. 61/072,861 filed Apr. 3, 2009.

### FIELD OF THE INVENTION

The present invention relates, in general, to dispensers and, more particularly, this invention relates to a dispensing device for use in making beverages.

### BACKGROUND OF THE INVENTION

Prior to the conception and development of the present invention, coffee machines as are generally well known in the prior art, have been used to dispense coffee and sometimes other hot drinks to users desiring such drinks. Such dispenser merely dispense the hot drink. Condiments such as creamer, sugar, sugar substitutes, spices, and the like may be situated somewhere near such dispenser or may be at a completely different location. Either way it is difficult for the user to obtain the desired condiments needed to personalize his or her drink to his or her specific tastes. Tearing open numerous packets of sugars, sugar substitutes, creamer, and the like can be cumbersome and messy and time consuming, as can be seeking specific spices, such as cinnamon, finding drink mixes, such as hot chocolate mix, instant coffee granules, and tea. In general, the use of such dispensers has, to date, been more of a chore than a convenience.

Specifically of interest to the present invention are the following: Wallace, et al, U.S. Pat. No. 6,145,705, discloses a dry condiment dispensing system in which the contents of the dispenser are dispensed through one or more dispensing holes at the bottom of a storage container. A stationary shutter is placed over the dispensing holes to prevent undesired dispensing of the contents of the dispenser.

Daniels, U.S. Pat. No. 4,674,657, discloses a dispenser of beverages prepared by combining hot or cold water with granulate. The dispenser is designed to dispense granulate directly from the container in which it is purchased at retail or from the manufacturer by incorporating a support funnel which will hold the container inverted.

Russillo, et al, U.S. Pat. No. 5,473,396, discloses a device which dispenses a condiment from a chamber. A push-valve extends the inside of the chamber through the bottom of the chamber. The valve has an up position which fills and stores a pre-selected amount of a condiment, and a down position which dispenses the condiment.

Bertone, U.S. Pat. No. 6,419,120, discloses a multi-flavor hot beverage dispenser apparatus. The dispenser apparatus has hopper to hold a base powder. The hopper includes a hopper dispenser outlet including a motor driven auger to dispense the base powder from the hopper and a hot water boiler and hot water dispense valve. A plurality of liquid flavor dispensers are selectively activatable to dispense a flavor syrup to flavor the dispensed hot drink. A mixer mixes the hot drink constituents.

The teachings of the above referenced U.S. Pat. Nos. 6,145,705; 4,674,657; 5,473,396; and 6,419,120 are incorporated herein by reference hereto.

None of the cited references provide the benefits attendant with the present invention.

### SUMMARY OF THE INVENTION

The present invention provides a dispensing device comprising a plurality of housing members manufactured from a first predetermined material and having a plurality of predetermined shapes and sizes for housing a plurality of predetermined consumable items therein. Each of such housing members is substantially a same height and depth. A securing means is disposed at predetermined locations on such housing members for releasably securing such housing members to each other. At least one housing member of such plurality of housing members is specifically for receiving and storing a predetermined amount of a predetermined liquid therein. A heating source is operably connected to such at least one housing member for heating such predetermined liquid. A power source is operably connected to such heating source for supplying power thereto. A switch means is disposed intermediate such power source and such heating source for selectively turning such power source on and off. A dispensing means is operably connected to each of such plurality of housing members for dispensing such predetermined consumable items from within such housing member outside of such housing members into predetermined containers.

### OBJECTS OF THE INVENTION

It is, therefore, one of the primary objects of the present invention to provide a dispensing device for use in making predetermined beverages.

Another object of the present invention is to provide a dispensing device which includes a plurality of interconnected housings for housing a plurality of predetermined consumable items such as heated water, instant coffee, instant cocoa mix, prepared coffee, predetermined condiments and the like and such that a user may choose which of such items to dispense into a predetermined container, for example such user could dispense instant coffee, hot water, sugar, and creamer into a cup to make a cup of coffee, such user could dispense hot water and instant cocoa mix into a cup to make hot chocolate, etc.

Still another object of the present invention is to provide a dispensing means for dispensing predetermined consumable items for making at least one predetermined heated beverage, such dispensing means including a predetermined plurality of housings, at least one of such housings being for housing water therein and being operably connected to a heating source for heating such water to a predetermined temperature.

Yet another object of the present invention is to provide a dispensing system for dispensing water, various drink mixes, and various condiments such that a user can make a predetermined beverage adding condiments to his or her liking.

An additional object of the present invention is to provide a dispensing system which includes a predetermined plurality of housing members for receiving and storing predetermined consumables therein, such housing members being releasably connectable to each other and mountable to at least one of a wall, a predetermined portion of a cabinet, a countertop, and a combination thereof.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which the invention has been mounted to a bottom portion of a cabinet via a frame and such plurality of housings are shown such that they have been moved away from at least one of a wall, such cabinet, and a combination thereof.

FIG. 3 is a partial schematic view of the heating system of such invention according to one embodiment of such invention.

FIG. 4 is a partial perspective rear view of the housings according to one embodiment of such housing members in which the securing means of such invention for securing such housing members to each other is illustrated as male portions and female portions disposed on predetermined sides thereof for engaging with each other.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

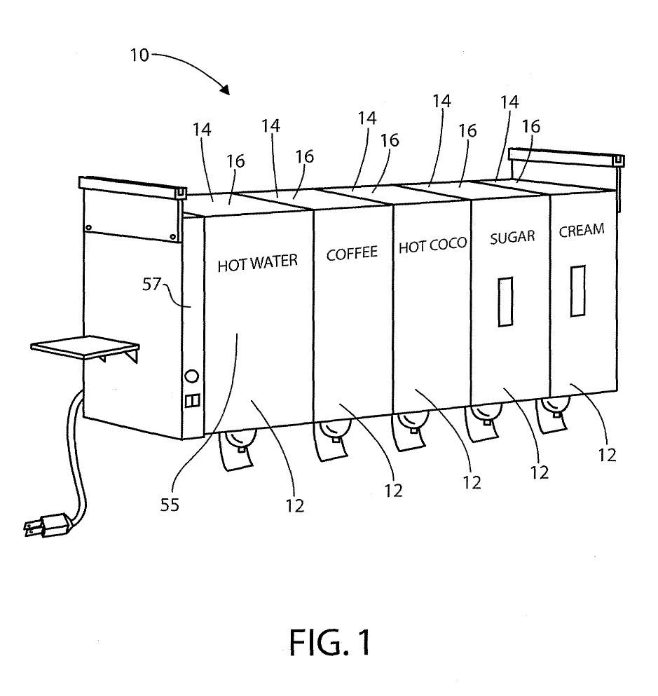

Reference is now made, more particularly, to FIGS. 1-4.

A dispensing device, generally designated 10 is provided. Such dispensing device 10 includes a plurality of housing members 12 manufactured from a first predetermined material and having a plurality of predetermined shapes and sizes for housing a plurality of predetermined consumable items (not shown) therein. Each of such housing members 12 is substantially a same height and depth.

It is presently preferred that such housing members 12 further each include an access means 14 disposed at a predetermined location thereon for enabling a user (not shown) to access an interior portion (not shown) thereof. It is presently most preferred that such access means 14 is a sliding lid member 16 releasably disposed on a top portion of each of such housing members 12. It is meant that such sliding lid member 16 be maneuverable by such user to access the interior of each housing for cleaning, refilling, and the like.

A securing means 52 is disposed at predetermined locations on such housing members 12 for releasably securing such housing members 12 to each other. Such securing means 52 may be any type of securing means reasonably facilitated to perform its purpose. As shown in FIG. 4 such securing means 52 may include predetermined select housing members being formed to include first male portions 53 disposed thereon on predetermined sides thereof engageable with second female portions 55 disposed on predetermined selected housing members on second predetermined sides thereof. Other various securing means may also be implemented to facilitate securing of such housing members together. It is further meant that the user be the ultimate decision maker as to how many housings he or she wishes to combine. For example, to begin with a user may only wish to have three housings, perhaps one for coffee, one for sugar, and one for sugar substitute. However upon use such user may determine that it would be beneficial and pleasing to have an additional housing for dispensing powdered creamer; the present invention will enable such user to easily add another housing to the others.

It is presently preferred that such plurality of housing members 12 are at least one of wall mountable, mountable to a predetermined portion of at least one cabinet, and a combination thereof. It is further presently preferred that such plurality of housing members 12 are mountable to a bottom portion of at least one kitchen cabinet 11.

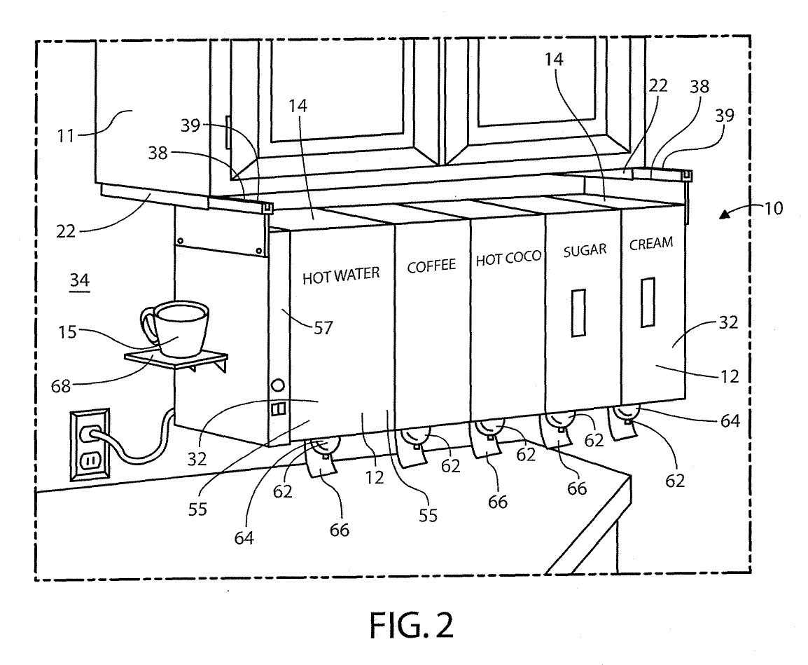

It is presently preferred that such device 10 further includes a pair of frame members 22, each frame member 22 being engageable with a predetermined side portion of a predetermined housing member 32 and with at least one of a predetermined portion of a predetermined wall 34, a predetermined portion of predetermined cabinet 11, and a combination thereof for mounting such dispensing device 10 at least one of on such predetermined portion of such predetermined wall 34, on such predetermined portion of such predetermined cabinet 11, and a combination thereof. It is further presently preferred that such frame members 22 each include a means 38 for facilitating movement of such housing members 12 such that such housing members 12 may be extended to a first position at least one of away from such predetermined wall, away from such predetermined cabinet, and a combination thereof and such that such housing members 12 may be returned to a second position at least one of closely adjacent such wall, closely adjacent such cabinet, and a combination thereof. It is preferred that such means 38 for facilitating movement of such housing members 12 is a drawer slide means 39 operably connected to at least one of such frame members 22, such predetermined housing members 32, and a combination thereof. As illustrated in FIG. 2 such plurality of housings is very easily moveable to accommodate such user in filling such housings, cleaning such housings, checking levels of consumables within such housings, and the like.

At least one housing member 55 of such plurality of housing members 12 is specifically for receiving and storing a predetermined amount of a predetermined liquid (not shown) therein.

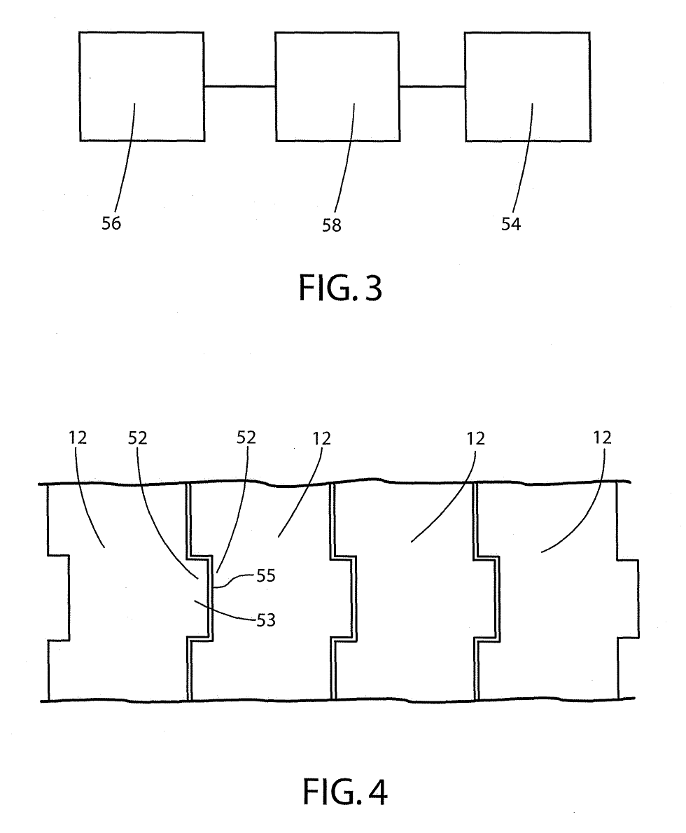

A heating source 54 is operably connected to such at least one housing member 55 for heating such predetermined liquid. A power source 56 is operably connected to such heating source 54 for supplying power thereto. A switch means 58 is disposed intermediate such power source 56 and such heating source 54 for selectively turning such power source 56 on and off. A partial schematic view of the heating system of the present invention is illustrated in FIG. 3. Such at least one housing 55 may include a separate chamber 57 for housing at least one of such heating source, such power source, such switch means, and a combination thereof.

As illustrated in FIGS. 1 and 2 the power to the device may be supplied by plugging the device into an electrical outlet of the structure in which such device 10 is situated. However the device is not meant to be limited as such and other forms of power, such as battery power, may also be used.

A dispensing means 62 is operably connected to each of such plurality of housing members 12 for dispensing such predetermined consumable items from within such housing members 12 outside of such housing members 12 into predetermined containers. According to a preferred embodiment, such dispensing means 62 is a spigot system 64 a spigot system disposed at least one of on a lower portion of each housing member, within a lower portion of each housing member, and a combination thereof. It is presently preferred that such spigot system 64 includes at least one of a push lever, a push button, and a combination thereof for maneuvering by such user such that such predetermined consumable items are dispensed as desired by such user. It is presently most preferred that such spigot system 64 includes a push lever 66. It is meant that a user need only push on such push lever 66 with a container such as a cup 15 or the like situated ready to receive dispensed items and the predetermined consumable item will be dispensed into the cup via the spigot system. There are, notably, numerous dispensing means, dispensing systems, and spigot systems which could be implemented to facilitate the purpose of dispensing such predetermined items. For example, some, but not all, spigot systems which could be used are described in the following U.S. patents the teachings of which are incorporated herein by reference thereto: Jacobus et al U.S. Pat. No. 6,533,003; Heydon et al U.S. Pat. No. 3,239,102; Nave U.S. Pat. No. 2,777,304; Bach et al U.S. Pat. No. 6,039,219; Kiriakides, Jr. et al U.S. Pat. No. 5,350,082. Additionally, dispensing systems as described in the teachings of U.S. Pat. Nos. 6,145,705; 4,674,657; 5,473,396; and 6,419,120 (as referenced earlier in this application) are also incorporated herein by reference. Therefore such dispensing means of the present invention may incorporate all or parts of the teachings of the above cited references alone or in combination with each other.

Furthermore, it is presently preferred that a shelf member 68 is disposed on such at least one predetermined housing member on a predetermined side thereof for enabling such user to place a cup 15 thereon for mixing predetermined items dispensed from such housing members 12 into such cup 15.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A dispensing device comprising:
a. a plurality of housing members manufactured from a first predetermined material and having a plurality of predetermined shapes and sizes for housing a plurality of predetermined consumable items therein, each of said housing members being substantially a same height and depth;
b. a first securing means disposed at predetermined locations on said housing members for releasably securing said housing members to each other;
c. at least one housing member of said plurality of housing members specifically for receiving and storing a predetermined amount of a predetermined liquid therein;
d. a heating source operably connected to said at least one housing member for heating said predetermined liquid;
e. a power source operably connected said heating source for supplying power thereto;
f. a switch means disposed intermediate said power source and said heating source for selectively turning said power source on and off; and
g. dispensing means operably connected to each of said plurality of housing members for dispensing said predetermined consumable items from within said housing members outside of said housing members into predetermined containers.

2. A dispensing device according to claim 1 wherein said dispensing means is a spigot system disposed at least one of on a lower portion of each housing member, within a lower portion of each housing member, and a combination thereof.

3. A dispensing device according to claim 2 wherein said spigot system includes at least one of a push lever, a push button, and a combination thereof for maneuvering by a user such that said predetermined consumable items are dispensed as desired by such user.

4. A dispensing device according to claim 3 wherein said spigot system includes a push lever.

5. A dispensing device according to claim 1 wherein said plurality of housing members are at least one of wall mountable, mountable to a predetermined portion of at least one cabinet, and a combination thereof.

6. A dispensing device according to claim 5 wherein said plurality of housing members are mountable to a bottom portion of at least one kitchen cabinet.

7. A dispensing device according to claim 1 wherein said housing members further each include an access means disposed at a predetermined location thereon for enabling a user to access an interior portion thereof.

8. A dispensing device according to claim 7 wherein said access means is a sliding lid member releasably disposed on a top portion of each of said housing members.

9. A dispensing device according to claim 1 wherein a shelf member is disposed on said at least one housing member on a predetermined side thereof for enabling a user to place a cup thereon for mixing predetermined items dispensed from said housing members into such cup.

10. A dispensing device according to claim 1 wherein said device further includes a pair of frame members each frame member being engageable with a predetermined side portion of a predetermined housing member and with at least one of a predetermined portion of a predetermined wall, a predetermined portion of predetermined cabinet, and a combination thereof for mounting said dispensing device at least one of on such predetermined portion of such predetermined wall, on such predetermined portion of such predetermined cabinet, and a combination thereof.

11. A dispensing device according to claim 10 wherein said frame members each include a means for facilitating movement of said housing members such that said housing members may be extended to a first position at least one of away from such predetermined wall, away from such predetermined cabinet, and a combination thereof and such that said housing members may be returned to a second position at least one of closely adjacent such wall, closely adjacent such cabinet, and a combination thereof.

12. A dispensing device according to claim 11 wherein said means for facilitating movement of said housing members is a drawer slide means operably connected to at least one of said frame members, said predetermined housing members, and a combination thereof.
